(19) United States
(12) Patent Application Publication
(10) Pub. No.: US 2019/0298081 A1
(43) Pub. Date: Oct. 3, 2019

(54) Child Seat

(71) Applicant: Suzhou Swandoo Children's Articles Co., Ltd., Suzhou (CN)

(72) Inventors: Nicolas Gonzalez Garrido, Vienna (AT); Hal Greenberger, Natick, MA (US)

(21) Appl. No.: 16/299,027

(22) Filed: Mar. 11, 2019

Related U.S. Application Data
(63) Continuation of application No. PCT/CN2017/101459, filed on Sep. 12, 2017.

(30) Foreign Application Priority Data
Sep. 12, 2016 (CN) 201610817633.0
Dec. 26, 2016 (CN) 201621440008.0

(51) Int. Cl. A47D 15/00; A47D 1/00; A47D 13/02; B60N 2/28; B62B 9/10; C09D 5/29; C09D 5/32

(52) U.S. Cl. CPC A47D 15/00; A47D 1/00; A47D 13/025; B60N 2/2848; B62B 2501/06; B62B 9/10; C09D 5/29; C09D 5/32; B60N 2/2845

(57) ABSTRACT

This disclosure relates to a child transportation device which may be a child seat or a stroller, or other device. The child seat comprises a basket and a base; the basket is arranged on the base. The basket is provided with a lifting handle. The child transportation device has a portion of the device configured to change color with temperature. The child transportation device may be provided with a temperature-sensing coating having the color change with the temperature change property. The temperature sensitive coating can be located anywhere on the child transportation device visible to external observers. The child seat is simple in structure and convenient to operate; and the temperature where a child locates is observed conveniently in a vehicle driving process or during indoor and outdoor conversion.

### CROSS-REFERENCE TO RELATED APPLICATIONS

This application is a continuation of and claims benefit of International Patent Application PCT/CN2017/101459 filed on 12 Sep. 2017, and also claims the benefit of Chinese Utility Model Patent Application No. 201621440008.0, filed Dec. 26, 2016, now pending, and Chinese Utility Model Patent Application No. 201610817633.0, filed Dec. 26, 2016, now pending, the contents of each of which are incorporated herein by reference in their entireties.

### BACKGROUND

This disclosure relates to a child seat and particularly to a child seat with a lifting handle having a temperature-sensing coating. More generally, this disclosure relates to a portion of a child transportation device which changes color as a function of ambient temperature, where the child transportation device may be a child seat, a child stroller, or an accessory useable with child seats and/or child strollers.

As the first choice for safe travel of children or infants in vehicles, people who drive need to install a child seat on a car seat. According to the direction, the child seats in a car are divided into horizontal hand-lifting type baby beds, which the infant carrier belongs to and which is suitable for infants within one year old, as an infant lies when the infant carrier is in use; backward type baby beds, which are equipped with a multi-point type safety belt and mostly suitable for children within 1-3 years old as the sitting direction of the children is always towards the rear side of the car and the children always lie obliquely in the backward type baby beds; forward type baby beds which are generally used in combination with adult safety belts as children sit in the beds normally with the sitting direction pointing forwards and which are suitable for children more than three years old; and convertible type baby beds which can be used in backward and forward forms and are generally suitable for children in a relatively big age range. As a child sits in the back row of the car while in motion, an adult when driving is difficult to sense the temperature of the position where the infant at the back row locates and is also inconvenient to sense the temperature as non-uniform indoor temperature is resulted from the limited blowing position of the air-conditioner when being turned on in hot summer or cold winter. Therefore, a child seat which can solve such problem is needed.

### SUMMARY

All examples and features mentioned below can be combined in any technically possible way.

In one aspect, a child transportation device includes a first portion, wherein the first portion is constructed and arranged so that it can change color when ambient temperature rises above a first predetermined threshold temperature.

Embodiments may include one of the following features, or any combination thereof. The child transportation device is a child seat. The first portion of the child transportation device is located in the handle of the child seat. The first portion of the child transportation device comprises a temperature sensitive coating, wherein the temperature sensitive coating changes from a first state to a second state when the ambient temperature exceeds the first predetermined threshold temperature, wherein the surface of the portion of the child transportation device located underneath the temperature sensitive coating has a color that is different from the color of uncoated surfaces of the child transportation device adjacent the location of the coating. The first state is opaque and the second state is transparent. The portion of the child transportation device coated with the temperature sensitive coating is further coated with a UV protective coating. The UV coating is transparent. The portion of the child transportation device coated with the temperature sensitive coating and the UV protective coating is further coated by an abrasion resistant transparent coating. The first portion of the child transportation device is located on a basket of the child seat. The first portion of the child transportation device is located on a front part of the basket of the child seat, the child transportation device further comprising a second portion located on a rear part of the child seat basket, the second portion constructed and arranged so that it can change color when ambient temperature rises above a second predetermined threshold temperature. The first and second threshold temperatures are the same. At least one of the first and second portions is visible from the front seat of a vehicle when the child transportation device in located in its intended orientation in the rear of the vehicle. The first portion of the child transportation device is located on a left side of the basket of the child seat, the child seat further comprising a second portion located on a right side of the basket, the second portion constructed and arranged so that it can change color when ambient temperature rises above a second predetermined threshold temperature. At least one of the first and second portions is visible from the front seat of a vehicle when the child seat in located in its intended orientation in the rear of the vehicle. The temperature sensitive coating is located in a recessed area. The child seat can be secured in a vehicle or secured to a base of a stroller. The child transportation device is a stroller

Embodiments may further include luminescent material, wherein the luminescent material is located adjacent to the first portion, wherein the luminescent material provides illumination to aid in observing the color change of the first portion at night. The luminescent material comprises a base layer and a photo-induced energy-storing luminescent layer arranged on the base layer.

In another aspect, an accessory for use with child transportation device includes a first portion of the accessory constructed and arranged so that it can change color when ambient temperature rises above a first predetermined threshold temperature, wherein the accessory is constructed and arranged so that it can be attached to the child transportation device.

Embodiments may include one of the following features, or any combination thereof. The accessory is a light source.

### BRIEF DESCRIPTION OF THE DRAWINGS

FIG. 1 is a perspective view of an example child transportation device that is a child seat and base.

FIG. 2A is a perspective view of an example child transportation device that is a child seat.

FIG. 2B is a side view of the example child seat of FIG. 2A.

FIG. 3A is a side view of an example child transportation device that is a child stroller.

FIG. 3B is a side view of an example child transportation device that is a child seat that is attachable to a child stroller base.

FIG. 4 is a side view of an example child seat with an attached accessory.

FIG. 5 is an illustration of coating layers applied to a substrate to obtain a color change with temperature property.

FIG. 6A is a perspective view of an example handle of a child car seat.

FIG. 6B is a cross section through the handle of FIG. 6A.

FIG. 7 is a perspective view of an example child transportation device that is a child seat and base, where the child seat incorporates luminesce.

FIG. 8 is a perspective view of an example handle of a child car seat.

### DETAILED DESCRIPTION

In order to overcome the defects in the prior art, in one non-limiting example a child seat is provided. A temperature-sensing coating having the color change along with the temperature change is arranged on the lifting handle of the basket of the child seat, so a person in a drive position or a co-driver position can judge the temperature of the position where the child is through observing the color of the lifting handle of the basket in a car in motion, thereby adjusting the temperature in the car conveniently and in time and enabling the infant to be at a suitable temperature.

In order to realize the purpose, one non-limiting example of the technical scheme is as follows: a child seat comprising a basket and a base, wherein the basket is arranged on the base; the basket comprises a main body and a lifting handle which is arranged on the main body and is convenient for lifting the basket; and the basket is provided with a temperature-sensing coating having the color changed along with the temperature change.

In one non-limiting example, the temperature sensitive coating is arranged on the lifting handle.

In one non-limiting example, the basket main body is provided with luminescent components capable of emitting out luminescent light.

In one non-limiting example, each luminescent component comprises a base layer and a photo-induced energy-storing luminescent layer additionally arranged on the base layer.

The child seat has the beneficial effects that the structure is simple; the temperature-sensing coating is arranged on the lifting handle, so the temperature of the environment where the infant is can be judged through different colors of the temperature-sensing coating which are variable along with the temperature change; the environmental temperature of the infant can be known through observing the color of the lifting handle in the car in motion or during the indoor and outdoor conversion, so parents can adjust the temperature in the car or add or reduce clothes conveniently and in time; and infants or children who are sensitive to the temperature can be protected in a better manner.

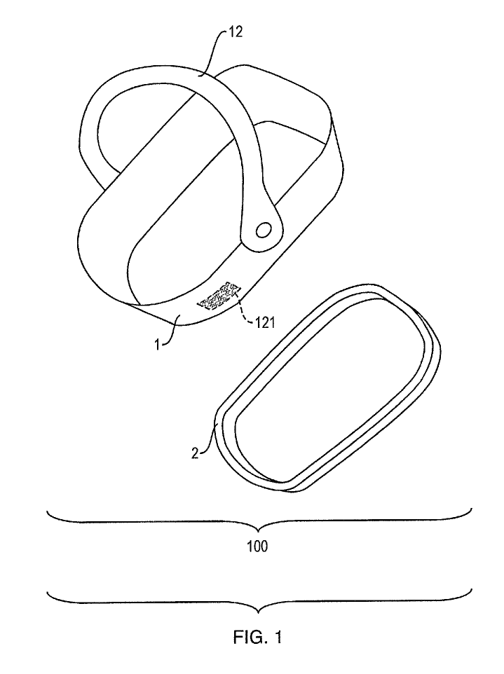

As shown in FIG. 1, child seat 100 comprises a basket 1 and a base 2. The basket 1 is provided with a lifting handle 12 used for lifting the basket conveniently; the basket 1 is provided with a temperature-sensing coating 121 which has different colors along with the change of the surrounding temperature; and the color of the temperature-sensing coating 121 along with the temperature change is reversible, that is to say, the color of the temperature-sensing coating 121 changes along with the rising temperature, and the color is taken on repeatedly at the same temperature when the temperature is reduced. A parent can judge the temperature of the environment where the child is based on color observation, a driver can accordingly judge the environmental temperature and adjust the temperature in the car conveniently during a car in motion, parents can be reminded in time of the environmental temperature where the children are and can know the temperature change in time in other indoor or outdoor environments, such as during a process from inside to the outside of a room or a market or from inside to outside of the car, thereby adding or reducing clothes of the children and protecting infants or children in a better manner. Of course, the temperature-sensing coating also can be applied to the lifting handle or a handrail or other places being conveniently observed by parents of the safety seat for a relatively big child.

In one non-limiting example, a portion of a child transportation device exhibits a property of visible color change as a function of temperature. A child transportation device may be a child seat such as seat 100 for use in a vehicle, a child seat for use with a bicycle, a stroller, or an accessory used with a child seat or stroller. Any portion of the child transportation device may have the visible color changing property. However, preferably the portion of the child transportation device exhibiting the color changing property with temperature is easily observable.

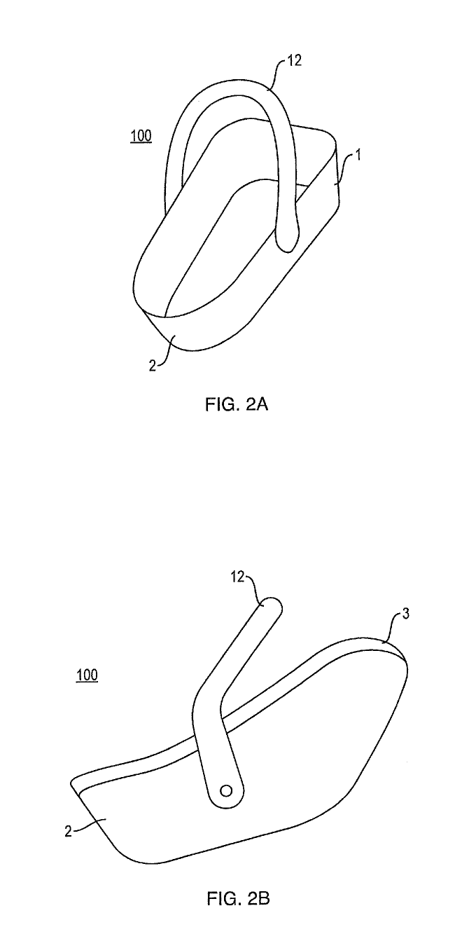

In one non-limiting example where the child transportation device is a child seat as depicted in FIG. 1, the portion of the child seat 100 incorporating the color changing property should at least be observable by an occupant of the front seat, and additionally should be visible by individuals located outside the vehicle, when the seat is affixed to a vehicle in its intended location and orientation. The portion may be a part of or the entirety of a handle 12 used to transport the seat. The portion may be a part of or the entirety of the seat basket 1 to which the handle 12 is attached. The portion may include parts of both the basket 1 and the handle 12. In one non-limiting example, the portion of the child seat incorporating the visible color changing property as a function of temperature may be a part of the seat having an upward facing and/or side facing surface. In one non-limiting example depicted in FIGS. 2A and 2B, a forward-facing surface 2 of a first part of the seat 100 and a rearward facing surface 3 of a second part of the seat 100 are both arranged to possess the color change with temperature property, so that at least one of these surfaces is visible regardless of the orientation of the seat in the vehicle.

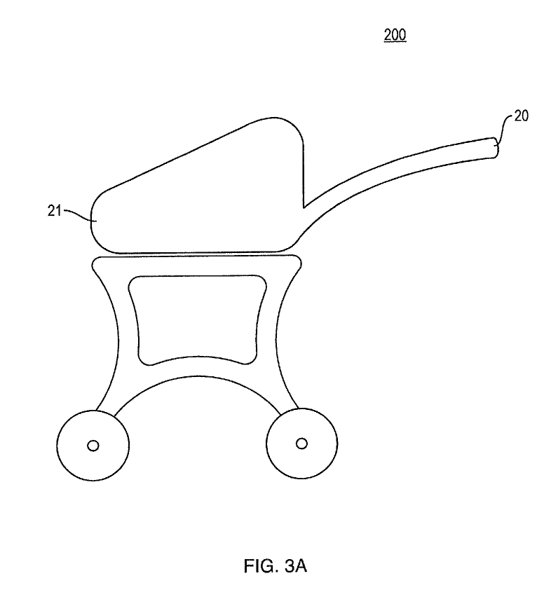

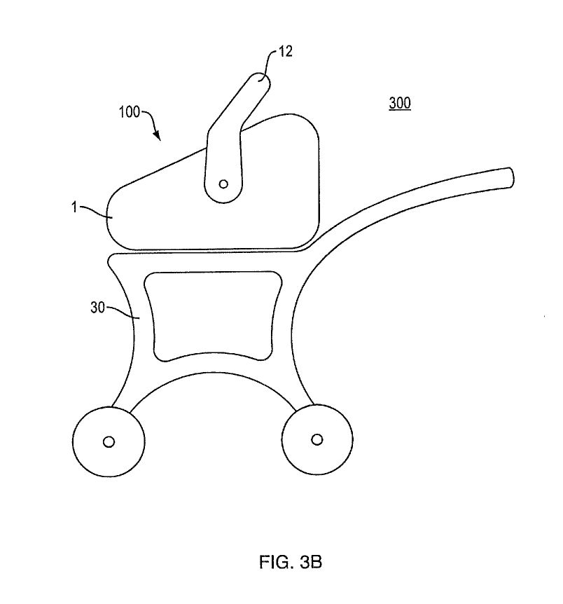

In one non-limiting example where the child transportation device is a child stroller, such as stroller 200 of FIG. 3A, the portion of the stroller 200 incorporating the visible color changing property should be observable anywhere nearby the stroller. The portion may be a part of or the entirety of a handle 20 used to transport the stroller. The portion may be a part of or the entirety of the basket 21. The portion may include parts of the basket 21 and parts of the handle 20. In one non-limiting example depicted in FIG. 3B, the child transportation device is a child safety seat such as seat 100 of FIG. 1 that can be affixed in a vehicle and alternatively affixed to stroller frame 30, allowing the child to easily be moved from a vehicle to a stroller without having to remove the child from the seat 100. In this example, a portion of the seat 100 is arranged to exhibit the color changing property with temperature, such as a portion of handle 12 and/or a portion of basket 1 (in a manner similar to locations described earlier in reference to the seat of FIGS. 1 and 2), where the portion of the seat 100 exhibiting the color change property is visible both to front seat occupants of a vehicle when the child seat 100 is located and oriented as intended in the vehicle (typically in the rear seat), and is also visible when the child seat 100 is affixed to the stroller frame 30.

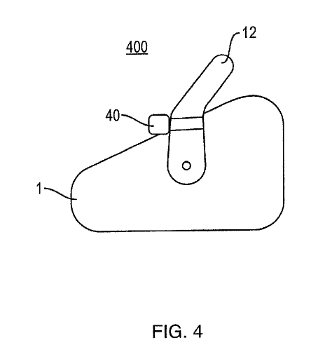

In one non-limiting example, a portion of an accessory for use with the child transportation device incorporates the visible color changing property. The portion of the accessory exhibiting the color changing property should be observable by an observer located nearby (for example, within 25 ft., though examples disclosed herein are not limited to a specific distance) and in direct line of sight with the accessory. With reference to the non-limiting example depicted in FIG. 4, child transportation device 400 is shown as a child seat but may also be any other type of child transportation device such as a stroller, a backpack, etc. Accessory 40 is shown affixed to handle 12, but could be affixed to other parts of child transportation device 400. The accessory could be any device one might wish to affix to a child transportation device, such as a light, an audio reproduction system, a camera, a sunshade, or any other known device one might wish to attach. When the accessory 40 is affixed to the child transportation device 400 as intended and the seat is located and oriented as intended a vehicle, the portion of the accessory having the color change property should be visible by front seat occupants (when they turn to face the car seat). If the accessory is affixed to another type of child transportation device, the portion of the accessory exhibiting the color changing property should be observable by an observer located nearby the device (for example within 25 ft., though examples disclosed herein are not limited to a specific radius).

In one non-limiting example, the child transportation device is a child seat that can be located in a vehicle or bicycle, or affixed to a stroller. A portion of an accessory exhibiting the color change with temperature property used with such a child transportation device should be visible by observers in the front seat of a vehicle or outside the vehicle when the seat is located inside the vehicle, and be observable by an observer located anywhere within a radius of the stroller when the seat is affixed to the stroller (for example, within a radius of 25 ft., though examples are not limited in the specific distance).

The portion exhibiting the visible color change as a function of temperature may be a part of or the entirety of the accessory. In one non-limiting example, the accessory may be configured so that it can be attached to a child seat, as depicted in FIG. 4. Alternatively, in one non-limiting example the accessory may be configured so that it can be attached to the child stroller (not shown). In one non-limiting example, an accessory is configured so that it can be mechanically attached to a child car seat or a child stroller. The accessory may be attached by clamping, snap fit, or use of threaded fasteners. Additionally, the accessory may be attached using magnetic connectors, adhesives, or any other known method of mechanically fixturing structures together. In one non-limiting example, the accessory can be attached to seat belts of the vehicle. In one non-limiting example, the accessory can be attached to the child or the child's clothing.

In one non-limiting example, a coating such as a temperature sensitive paint or coating is applied to a portion of a child transportation device. In one non-limiting example, a two-layer coating is used, where a first transparent layer is part # TYK-PP0837 and a 2^{nd} thermoresistive layer is part # TYK-BK0962, both available from Donglai Colorpro Coating Technology Co., LTD. Address: No. 1221, Xin-He Rd., Jia-Ding Industrial Park, shanghai City, China. The coating can be applied to plastic, metal, or other materials. In one non-limiting example, the paint is in a first optical state, which in one non-limiting example is opaque, when the temperature is below a preset threshold temperature, and the paint transitions to a second optical state which may be transparent, when ambient temperature exceeds the threshold temperature. The state of the coating is reversible so that if ambient temperature returns to a level below the threshold temperature, the coating reverts to its first state. In one non-limiting example, the transition from the first state to the second state (e.g. opaque to transparent) happens over a small temperature range around the threshold temperature, for example between 37° C. and 41° C., and the coating reverts back to its first (opaque) state over the temperature range between 36° C. and 33° C. Once the coating has fully reverted to its first state, it will transition to its second state in the same temperature range as identified earlier. In other words, temperature cycling does not significantly alter the transition temperature ranges.

The threshold temperature can be chosen as desired. In the case of child transportation devices and accessories, the threshold temperature is chosen to be a temperature beyond which exposure is potentially dangerous. In one non-limiting example, the threshold temperature is chosen to be 37°±1° C., which is the average human body temperature. It is also a relatively high temperature to have children exposed to for any extended period of time. By choosing average body temperature as the threshold temperature, handling of the child transportation device by gripping a handle which has the temperature sensitive coating applied will not cause the coating to transition to its transparent state.

In one non-limiting example, a temperature sensitive coating is applied to a portion of the child transportation device. Below the threshold temperature of the coating, the surface of the child transportation device covered by the temperature sensitive coating is obscured from view as the coating is in its first opaque state. When the ambient temperature exceeds the threshold temperature, the temperature sensitive coating transitions to a transparent second state, and the surface of the coated portion of the child transportation device (the substrate surface underneath the temperature sensitive coating) now becomes visible.

The portion of the child transportation device covered by the temperature sensitive coating, the substrate material underneath the coating that is part of the child transportation device surface, is configured to provide information to an observer that high temperatures are present. In one non-limiting example, the color of the portion of the child transportation device surface covered by the temperature sensitive coating is treated to have a color different from surrounding or adjacent portions of the child transportation device. This different color becomes visible when the ambient temperature exceeds the threshold temperature and the coating transitions to its second, transparent state, so that the surface underneath the coating becomes visible. The color of this coated portion of the child transportation device may be black so that the black color becomes visible when the threshold temperature is exceeded, though a designer is free to choose the particular color scheme used. In one non-limiting example, the portion of the child transportation device covered by the temperature sensitive coating may have printed information such as the words “HOT” or “WARNING”, or “DANGER”, or some other suitable warning. The information may be printed in a color such as black, though any color scheme can be chosen by a designer. Images or icons may substitute for or may be combined with color and/or text to provide further information. Examples are not limited in the visible patterns or images that are applied to the coated portion of the child transportation device. When the ambient temperature exceeds the threshold temperature of the coating, the coating transitions to its second, transparent state, and the surface of the child transportation device covered by the coating becomes visible so that any information printed on the surface also now becomes visible, including text, icons, or simply the color of the underlying surface.

In one non-limiting example, more than one portion of a child transportation device may be coated with temperature sensitive coatings as described above. Different portions of the child transportation device may be coated with different formulations of temperature sensitive coatings having different threshold temperatures. In this example, a first portion of the child transportation device becomes visible when a first threshold temperature is exceeded (which may be 37° C., or may be lower or higher), and a second portion of the child transportation device becomes visible when a second threshold temperature which is higher than the first threshold temperature (such as be 42° C.) is exceeded. The first and second portions may have the same or different colors applied prior to having the coating applied, and may have different text and or images applied. In one non-limiting example, a first word such as “WARNING” bay become visible when the first threshold temperature is exceeded, and a second word “DANGER” may become visible when the second threshold temperature is exceeded. In one non-limiting example, more than two regions may also be used, and more than two different formulations of temperature sensitive coating may be used so that more than two transition temperatures are implemented.

In one non-limiting example, the coating in its first state, in addition to being opaque also has a pigment. The color of the pigment in the first state can be chosen as desired by a designer and is not limited to any particular color. For example, the color of the pigment may be chosen to match the color of the substrate material of the child transportation device so that when the coating is in its opaque state, there is no readily discernable feature that distinguished a coated section from an uncoated section of the device. In other words, the presence of the coating cannot be detected by a casual observer when the coating is in its first state.

In one non-limiting example, the pigment of the coating is chosen to be a color different from the color of the surrounding structure of the child transportation device. This identifies the area that will exhibit the color change with temperature property. When the ambient temperature exceeds the threshold temperature for the coating, the coating transitions to its second, transparent state, and the substrate material of the child transportation device underneath the coating becomes visible. As described previously, this area can be made to be a color different from the surrounding device structure, and can also be made to be a different color than the pigment of the coating.

In one non-limiting example, a portion of a child transportation device or an accessory exhibits a color changing property as a function of temperature at two or more transition temperatures. The portion of the device may have a first color when the ambient temperature is below a first threshold temperature. The color of the portion changes to a second color when ambient temperature exceeds the first threshold temperature but does not exceed a second threshold temperature. The color of the portion changes to a third color when ambient temperature exceeds the second threshold temperature. More than two threshold temperatures can also be accommodated.

In the above example, the portion of the device exhibiting the color changing property can be coated with two or more different coating layers having different formulations. The portion of the device surface underneath the coating is treated to be the 3rd color. A coating is applied that has pigment of the 2^{nd} color and it changes state at the second transition temperature. On top of this coating is another coating. This top coating has pigment of the first color and it changes state at the first transition temperature. Of course, as described earlier, words, icons or other informational markings can be printed onto the surface of the child transportation device before coatings are applied so that this information becomes visible once all the coating layers covering it have transitioned to a transparent state.

In one non-limiting example, the temperature-sensing coating 121 is in gray at less than 10 DEG C, is in green within 10 DEG C to 15 DEG C, is in yellow within 15 DEG C to 20 DEG C, is in red within 20 DEG C to 25 DEG C and is in purple within 25 DEG C to 30 DEG C. Of course, the coating with the suitable temperature range can be selected based on the demand. When the coating color is in red, it indicates that that the infant is within a relatively suitable temperature; and when the coating color is in green, it indicates that the temperature is relatively low and the air-conditioner can be turned on appropriately for adjusting the temperature in the car.

In one non-limiting example, the temperature sensitive coating is covered with a UV protective coating. The UV protective coating must be sufficiently transparent such that the coatings and surfaces of the coated structures underneath the UV protective coating are visible (when the temperature sensitive coating transitions to its transparent state). The UV protective coating must not interfere with state transition of the temperature sensitive coating. A UV protective coating can be formed by filling a base layer resin with materials that are UV absorptive. Resins capable of being utilized as a base layer in a UV protective coating include polyurethane, epoxy, acrylic, polyvinyl alcohol, polyvinyl acetate, polyvinyl chloride, polyester, polyimide, polyether ether ketone, and polycarbonate. The UV absorptive materials may be nano-scale particles of titanium dioxide, iron oxide or other UV blocking inorganic material. Alternatively, the nano-scale particles may be used in combination with well-established organic UV blockers such as Tinuvins™ (Ciba) to yield very strong UV protection while allowing full transmittance of the visible/IR wavelengths that lead to heating.

In one non-limiting example, a UV protective coating may provide a degree of wear protection to limit wear of the temperature sensitive coating. In one non-limiting example, an additional transparent coating may be applied to provide increased wear resistance.

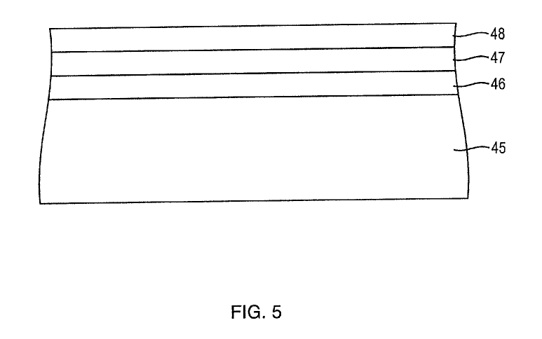

Depicted in FIG. 5 is an arrangement of coating layers on a substrate material 45, such as a polymer material that would be used to form a component of a child transportation device. Coated on top of substrate 45 is temperature sensitive coating material 46. As described above, coated on top of temperature sensitive coating 46 is UV protective coating 47. As described above, if the UV coating does not provide sufficient resistance to abrasion, abrasion resistant coating 48 may be coated on top of UV coating 47, to protect the coating layers underneath. Abrasion resistant coating 48 must be sufficiently transparent so that the coating layers underneath are visible. Similarly, UV protective coating 47 must also be sufficiently transparent so that coating temperature sensitive 46 is visible.

In one non-limiting example, a temperature sensitive coating is applied to a portion or portions of the child transportation device that see less friction in use. For example, the coated portion may be located on an exterior side wall that is not configured to be grasped by a person transporting the child transportation device and does not rest against vehicle surfaces when the child transportation device is placed in a vehicle, yet it is still visible by a front seat occupant when the child transportation device is located as intended in a vehicle, and/or is visible to nearby observers of a stroller in which the child transportation device may be located. This reduces wear and increase the life of the temperature sensitive coating.

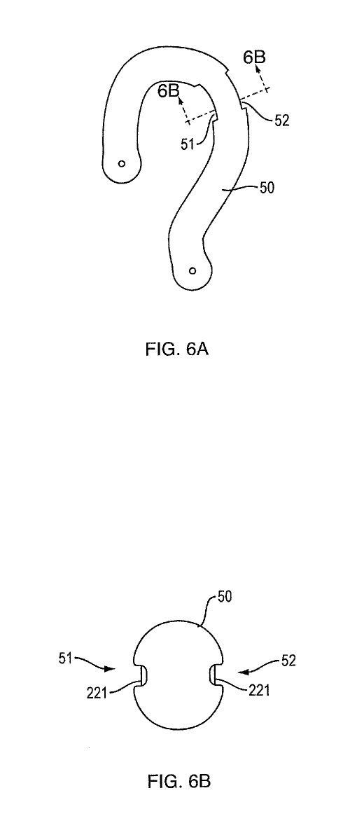

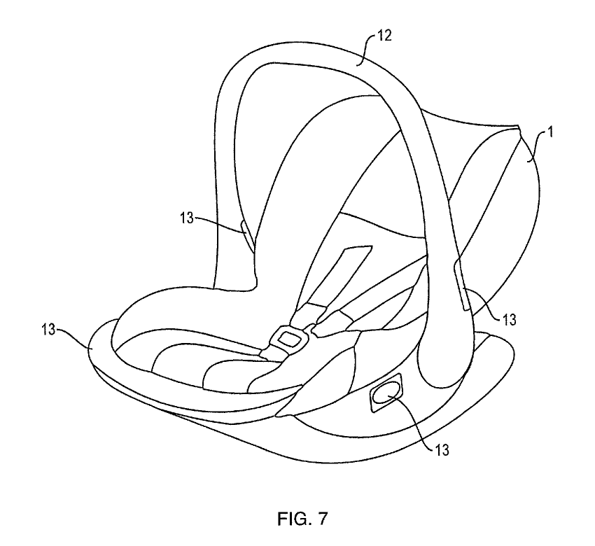

In one non-limiting example, a temperature sensitive coating is applied to a handle. In one non-limiting example, the temperature sensitive coating transitions from an opaque state to a transparent state in a small range around a transition temperature. When the coating is in its transparent state, the surface of the portion of the handle underneath the coating becomes visible, as described previously. The handle is easily observable from outside the vehicle or by occupants in the front seat of the vehicle. In the non-limiting example depicted in FIGS. 6A and 6B a temperature sensitive coating 221 is applied to a portion of the handle that is slightly recessed from outer surfaces of other portions of the handle 50 such that rubbing and wear of the coated portion is reduced. FIG. 6A depicts the handle of a child transportation device which may be a child seat, a stroller, or other transportation device. FIG. 6B depicts a cross section taken along section A-A of FIG. 6A. Coating 221 rests within recessed regions 51 and 52 such that when handle 50 is grabbed, the user's hands do not rub against the coated surface, thus reducing wear. The temperature sensitive coating 221 may also be coated with a UV protective coating as described earlier. While not required because the coating now resides in a recessed area, an abrasion resistant coating may also be used if desired. It should be understood that the coating may be applied to a recessed area located anywhere on a child transportation device, and is not limited to being applied to a recessed portion of a handle.

In one non-limiting example, a material possessing the property of color change as a function of temperature is used to form a portion of a child transportation device. In one non-limiting example, a thermochromic polymer material is available from KUMHO-SUNNY, located at: No. 1399, Jigao Road, Huacao Town, Minhang District, Shanghai, China. The material can be used to form a complete component, or a material can be co-injected in a manner such that a portion of a component part of the child transportation device is formed from a first material having a color change property as a function of temperature and a second material that does not have the color changing property. The material can be used in components and locations that are visible to observers and front seat occupants of a vehicle as described earlier. That is, rather than using a coating or a paint that transitions between states as a function of temperature, a material such as a polymer material that can be injection molded or formed through other common industrial forming processes (such as extrusion, vacuum forming, pressing etc.) has a property of color change as a function of temperature. This can be accomplished by adding a colorant to the polymer material that has the desired color change property, such that when a threshold temperature is exceeded, the colorant changes color and is visible to observers. The use of a material can be substituted for the earlier described coating, for all of the previously described examples of child transportation devices and accessories. Examples disclosed herein are not limited in the manner in which they achieve their color change with temperature property, and any other known method is also contemplated.

Furthermore, as shown in FIG. 7, the basket also can be provided with luminescent components capable of emitting out luminescent light, so that the infant basket when being combined with a stroller has a luminescent prompting function at night, another person can easily distinguish that a child is in front and the child is prevented from being hit by coming and going vehicles. In the embodiment, the luminescent components 13 are arranged at the left side, the right side and the surface of the rear part of the basket 1 and also can be arranged on the other positions of the basket 1. The luminescent components 13 are wholly in a semi-transparent state which makes the whole basket be beautiful. During the specific implementation, the luminescent components 13 can be formed by mixing a polypropylene material (PP material) and photo-induced energy-storing luminescent powder according a certain volume proportion. The experiments show that the luminescent effect of the luminescent components is not very good at the presence of less than 4% volume proportion, and the transparent effect of the luminescent components is not very good in the presence of higher than 10% volume proportion. As a result, the volume of the photo-induced energy-storing luminescent powder is 4%-10% of the whole volume of the luminescent components. Of course, other volume proportion is also suitable, that is to say, the volume proportion greater than 0% but less than 100% is contemplated within.

Any portion of a child transportation device may incorporate luminescent material. In one non-limiting example, luminescent material is incorporated in a portion of the child transportation device adjacent to the portion of the child transportation device that exhibits the property of color change as a function of temperature. By incorporating luminescent material adjacent to a portion of the child transportation device that exhibits the color changing property, it becomes possible to observe the color of the material at night when no other source of illumination is present.

In one non-limiting example, luminescent material is incorporated in portions of the child transportation device that are in any way accessed or manipulated during use. In one non-limiting example where the child transportation device is a child seat, any portion of the child seat that is accessed or manipulated during installation of the seat in a vehicle may incorporate luminescent material such that those components can be illuminated by the luminescent material in low light conditions such as at night. For example, structures near where a vehicle seat belt is routed through the child seat may have luminescent material, structures that are part of or are adjacent to the child seat harness or buckles may incorporate luminescent material. Areas near where the child seat attaches to a seat base may also incorporate luminescent material. Examples are not limited in the locations where luminescent material may be used in a child transportation device such as a child seat.

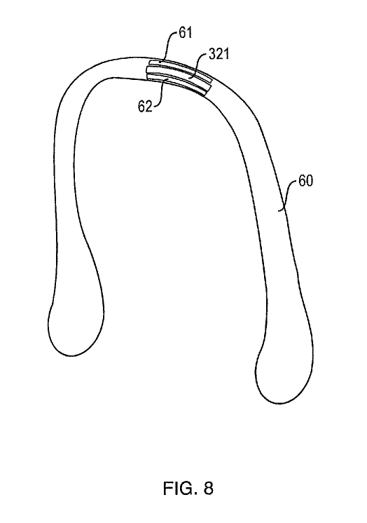

Referring now to FIG. 8, one example of arranging luminescent material near a portion of a child transportation device that changes color as a function of temperature is shown. In this example, a handle 60 of a child car seat is shown, but a similar arrangement can be used anywhere the temperature sensitive coating or material is used. Luminescent strips 61 and 62 are arranged adjacent to the region 321 which exhibits the color change with temperature property. Region 321 may have a temperature sensitive coating as described earlier, or may be formed from a material having the color change with temperature property. The strips 61 and 62 absorb energy from sunlight during the day and fluoresce when sunlight is not present, thus providing a degree of illumination. The illumination from the luminescent material is used to illuminate the region having the color change with temperature property, so that the color change is observable at night. While one arrangement of color changing region and luminescent material is shown, examples are not limited to this arrangement. Any geometry of regions is possible, as long as the luminescent material is sufficiently close to the color changing region to illuminate the region to improve visibility under low or no light conditions.

In one non-limiting example, a separate light source such as an LED light is incorporated into the child transportation device. The light source is arranged such that it can illuminate a portion of the child transportation device that exhibits the color changing property. The output from the light source can be directed such that it illuminates the portion of the child transportation device that exhibits the color changing property but does not significantly illuminate the area where the child's head would be located so that the light source does not disturb the child. In one non-limiting example, the LED light source can be attached to a child transportation device as an accessory, such as accessory 40 of FIG. 4. Portions of accessory 40 may be configured to have the color change with temperature property, as discussed elsewhere in this disclosure. In this example, the LED light source can be used to illuminate the portion of the accessory having the color change property so that the color change is observable at night or under low light conditions. Alternatively or additionally, the light source can be used to illuminate a portion of the child transportation device that exhibits the color change with temperature property, so that the color change of this portion of the child transportation device can be observed at night or under low light conditions.

When a car is in motion, parents sitting at the driver position and the co-driver position are convenient to observe the temperature environment of the position where the infant in the seat at the back row locates. By observing the color change of the coating on the lifting hand, the temperature can be judged and adjusted in time, so that the infant can be in a suitable temperature environment.

A number of implementations have been described. Nevertheless, it will be understood that additional modifications may be made without departing from the scope of the inventive concepts described herein, and, accordingly, other embodiments are within the scope of the following claims.

What is claimed is:

1. A child transportation device wherein a first portion of the child transportation device is constructed and arranged so that it can change color when ambient temperature rises above a first predetermined threshold temperature.

2. The child transportation device of claim 1 wherein the child transportation device is a child seat.

3. The child transportation device of claim 2 wherein the first portion of the child transportation device is located in the handle of the child seat.

4. The child transportation device of claim 1 wherein the first portion of the child transportation device comprises a temperature sensitive coating, wherein the temperature sensitive coating changes from a first state to a second state when the ambient temperature exceeds the first predetermined threshold temperature, wherein the surface of the portion of the child transportation device located underneath the temperature sensitive coating has a color that is different from the color of uncoated surfaces of the child transportation device adjacent the location of the coating.

5. The child transportation device of claim 4 wherein the first state is opaque and the second state is transparent.

6. The child transportation device of claim 1 wherein the portion of the child transportation device coated with the temperature sensitive coating is further coated with a UV protective coating.

7. The child transportation device of claim 6 wherein the UV coating is transparent.

8. The child transportation device of claim 7 wherein the portion of the child transportation device coated with the temperature sensitive coating and the UV protective coating is further coated by an abrasion resistant transparent coating.

9. The child transportation device of claim 2 wherein the first portion of the child transportation device is located on a basket of the child seat.

10. The child transportation device of claim 9 wherein the first portion of the child transportation device is located on a front part of the basket of the child seat, the child transportation device further comprising a second portion located on a rear part of the child seat basket, the second portion constructed and arranged so that it can change color when ambient temperature rises above a second predetermined threshold temperature.

11. The child transportation device of claim 10 wherein the first and second threshold temperatures are the same.

12. The child transportation device of claim 10 wherein at least one of the first and second portions is visible from the front seat of a vehicle when the child transportation device in located in its intended orientation in the rear of the vehicle.

13. The child transportation device of claim 9 wherein the first portion of the child transportation device is located on a left side of the basket of the child seat, the child seat further comprising a second portion located on a right side of the basket, the second portion constructed and arranged so that it can change color when ambient temperature rises above a second predetermined threshold temperature.

14. The child transportation device of claim 13 wherein at least one of the first and second portions is visible from the front seat of a vehicle when the child seat in located in its intended orientation in the rear of the vehicle.

15. The child transportation device of claim 4 wherein the temperature sensitive coating is located in a recessed area.

16. The child transportation device of claim 2 wherein the child seat can be secured in a vehicle or secured to a base of a stroller.

17. The child transportation device of claim 1 wherein the child transportation device is a stroller.

18. The child transportation device of claim 1 further comprising luminescent material, wherein the luminescent material is located adjacent to the first portion, wherein the luminescent material provides illumination to aid in observing the color change of the first portion at night.

19. The child transportation device of claim 1 wherein the luminescent material comprises a base layer and a photo-induced energy-storing luminescent layer arranged on the base layer.

20. The child transportation device of claim 1 wherein the first portion of the child transportation device comprises a thermochromic polymer material, wherein the thermochromic polymer material changes from a first state to a second state when the ambient temperature exceeds the first predetermined threshold temperature.
